(19) United States
(12) Patent Application Publication
(10) Pub. No.: US 2002/0089583 A1
(43) Pub. Date: Jul. 11, 2002

(54) Three-dimensional visual inspection method of semiconductor packages and apparatus using single camera

(75) Inventors: Bum Jae You, Seoul (KR); Sang Rok Oh, Seoul (KR); In So Kweon, Daejon City (KR); Doo Hyun Lee, Sungnam City (KR)

Correspondence Address: BACON & THOMAS, PLLC, 625 SLATERS LANE, FOURTH FLOOR, ALEXANDRIA, VA, 22314

(73) Assignee: Korea Institute Of Science and Technology, Seoul (KR)

(21) Appl. No.: 09/903,526

(22) Filed: Jul. 13, 2001

(30) Foreign Application Priority Data
Oct. 27, 2000 (KR) 63402

(51) Int. Cl. H04N 13/00

(52) U.S. Cl. 348/42; 382/154

(57) ABSTRACT

The present invention relates to a three-dimensional visual inspection method of semiconductor packages and apparatus using single camera, which is able to carry out a three-dimensional visual inspection of small-size, high-density semiconductor packages having a large-scale of integration by using a single camera. The present invention presents an optical system that can obtain a stereo image to extract distance information by using an LED light and a single camera, and it also presents a three-dimensional measurement/inspection method using the same.

### BACKGROUND OF THE INVENTION

1. Field of the Invention

The present invention relates to a three-dimensional visual inspection method of semiconductor packages and apparatus Thereof, and more particularly relates to a three-dimensional visual inspection method of semiconductor packages and apparatus using single camera, which is able to carry out a three-dimensional visual inspection of small-size, high-density semiconductor packages having a large-scale of integration by using a single camera.

2. Description of the Related Art

Recently, as the integration scale of semiconductor element becomes to be large and the size of element rapidly reduces, the production of semiconductor element using an appropriate package style for a high-density element, such as a ball grid array (BGA) package, a plastic quad flat package (PQFP), or a small outline package (SOP), increases. Here, a BGA package is formed by adhering an element directly to a through-hole of an electronic circuit board by heating a circular-shape lead placed at the bottom of the element, and an SOP is achieved by densely forming numbers of very-fine legs on all sides of the package and the element.

In case of the packages having a style of PQFP or SOP above mentioned, neighboring legs had been arranged generally with the space of larger than 1.0 mm in the past, however the space between legs is recently reduced to under 0.2 mm, which can be hardly recognized by human eye. Therefore, a three-dimensional inspection becomes to be required.

Because the above-described packages are assembled by being pressed with heat at the top or bottom of an electronic circuit board, if the heights of balls adhered to the bottom of the element is not uniform or the heights of the legs formed at the sides of the element are not uniform, the whole board is not usable due to contact failure.

To solve these problems, an inspection method to check whether the heights of the legs or the balls of the element are uniform or not is required.

The three-dimensional inspection methods used in the prior art employ a method using two cameras or a method using a camera and a laser source of which the interrelationship is known. They obtain the distances from camera to the balls (or legs), construct a plane by these data, and thereby check whether the height is uniform or not.

Here, the method using two cameras has disadvantages that, in case that the size of the element becomes small, the installation of cameras is difficult and the measurement accuracy becomes low.

And, the method using a camera and a laser source has disadvantages that the price of the equipment becomes high in order to construct a laser source, which provides a thin laser light having a thickness less than 0.1 mm, and it is difficult to obtain the interrelationship between the camera and the laser source.

### SUMMARY OF THE INVENTION

The present invention is proposed to solve the problems of the prior art mentioned above. It is therefore the object of the present invention to provide a three-dimensional visual inspection method of semiconductor packages and apparatus thereof, which carries out a three-dimensional visual inspection by using a single camera without using an additional special light source like a laser light source and lowers the system price to be less than 50% of that of the prior three-dimensional visual inspection apparatus thereby.

To achieve the object mentioned above, the present invention presents a visual inspection method of semiconductor packages using a single camera, which is able to carry out a three-dimensional visual inspection that has been recently required as the integration scale of the semiconductor element becomes large and the size of the element becomes small.

In more detail, the present invention presents a three-dimensional visual inspection method that is applicable to measure the height of the balls in a ball grid array (BGA) package which is formed by adhering an element directly to a through-hole of an electronic circuit board by heating a circular-shape lead placed at the bottom of the element, or to measure the height of the legs in a small outline package (TSOP or TTSOP) which is formed by densely attaching numbers of very-fine legs on all sides of the element.

### BRIEF DESCRIPTION OF THE DRAWINGS

FIG. 1 is a view illustrating the structure of a three-dimensional visual inspection method in accordance with the present invention.

FIG. 2 is a perspective view of a prism in accordance with the present invention.

FIG. 3 is a view illustrating the concept of imaging principle using a prism in accordance with the present invention.

FIG. 4 is a view illustrating the field of view (FOV) of a real camera using a prism in accordance with the present invention.

FIG. 5 is a view illustrating the field of view (FOV) of a virtual stereo camera using a prism in accordance with the present invention.

FIG. 6 is a sample image of a micro-BGA package element obtained without using a prism in accordance with the present invention.

FIG. 7 is a sample image of a micro-BGA package element obtained by using a prism in accordance with the present invention.

FIG. 8 is a flow chart illustrating the image processing procedures in accordance with the present invention.

### DESCRIPTION OF THE NUMERALS ON THE MAIN PARTS OF THE DRAWINGS

10: an image processing system

12: a camera

14: a prism

16: a lighting means

18: a package element

20: an image plane

22: a camera lens

### DETAILED DESCRIPTION OF THE EMBODIMENTS

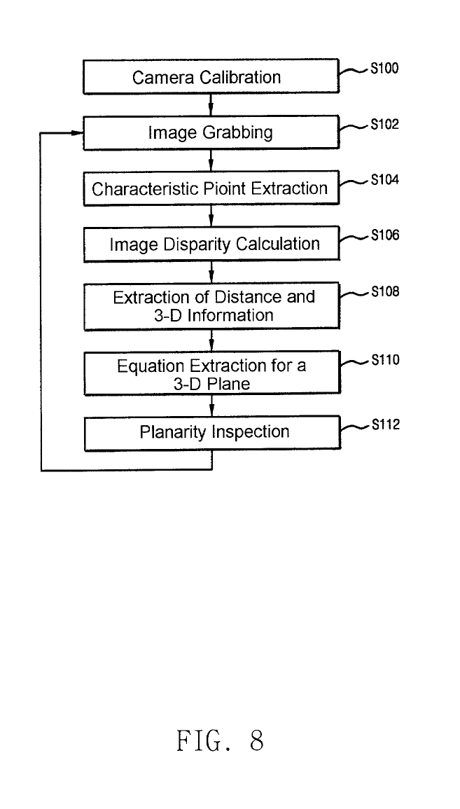

Hereinafter, referring to appended drawings (FIG. 1˜FIG. 8), the structure and the operation procedures of the embodiments of the present invention are described in detail.

The basic concept of a three-dimensional visual inspection method in accordance with the present invention is illustrated in FIG. 1.

A lighting means (16) is located over the package element (18) to be inspected to lighten the element, a camera (12) is installed over the lighting means (16), and a prism (14) is inserted between the camera (12) and the package element (18).

The stereo images obtained through the prism (14) are read by a camera (12), input to the image processing system (10), and processed therein for three-dimensional visual inspection.

In other words, coplanarities of main characteristic points of the element are measured and inspected by measuring the distances from the camera (12) to the corresponding points.

The image processing system (10) is constructed to be a PC-based system or an embedded system.

The prism (14) is made of a transparent material, such as a glass or a crystal, and it has a trigonal shape.

A light emitting diode (LED) is a desirable lighting means (16).

Since an LED has an irregular reflection characteristic in itself, it eliminates the inhomogeneous reflection light partially reflected at the surface of the subject, such as a highly-reflecting metal surface, and obtains a stable image thereby.

In addition, since the ball in BGA package has a spherical shape, if a ring-type light is applied from the lower position, a doughnut-shaped image of which the circumference is bright and the center is dark can be obtained. Therefore, a ring-type LED is desirable for inspecting a BGA package since the image processing to extract the vertex of the ball is easy.

The optical path of the light from the package element (18) transmitted through the prism (14) in FIG. 1 is split into two directions, and thereby a single spatial point is mapped in two different points on the image plane (20). As a result, a three-dimensional inspection can be carried out since a stereo image can be obtained by a single camera.

In the prior art which obtains a stereo image using two cameras, the characteristics (focal length, exposure, zoom, etc.) of the lenses equipped in two cameras are different from each other. And it is very difficult to mechanically fix the two cameras for their optical axes to be parallel. (In reality, it is impossible.) Therefore, it requires a complicated algorithm to process the image for compensating these defects.

On the other hand, in case of using single camera (12) and a prism (14) like the present invention, the problems described above are not occurred since the image is read through a single camera lens (22).

In particular, a process of calculating an epipolar line to find the corresponding points on the stereo image is eliminated and the images existing on the same horizontal line are to be analyzed.

Therefore, the whole system efficiency is improved as the image processing becomes to be simple and the image processing speed becomes to be fast.

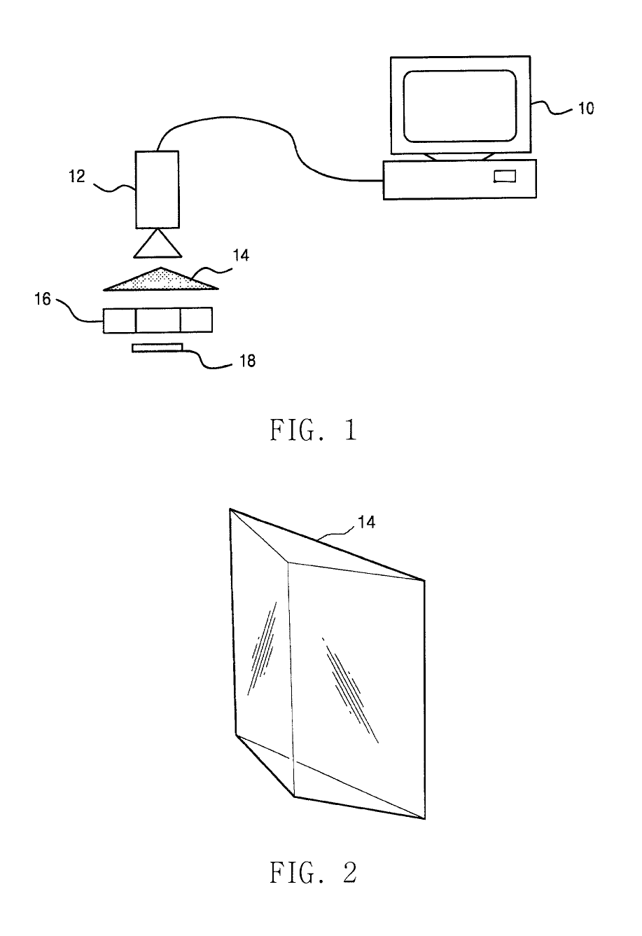

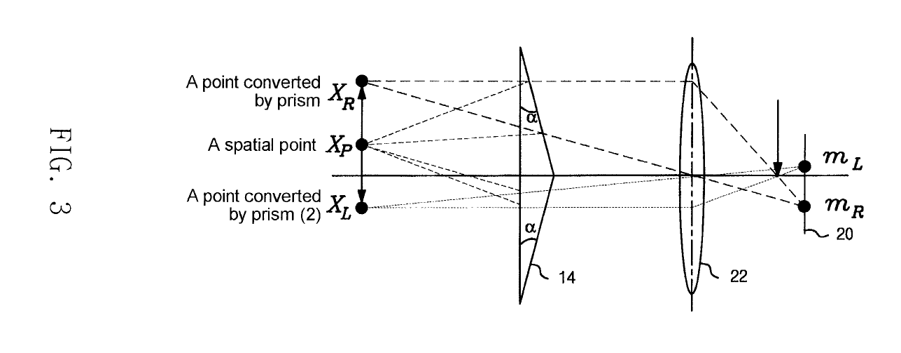

FIG. 2 is a perspective view of a prism in accordance with the present invention, and FIG. 3 is a view illustrating the concept of imaging principle by which a single spatial point is mapped into two different points on the image plane.

As described in FIG. 3, a single spatial point, XP, is converted to two different points, XR and XL, by the prism (14), and thereafter mapped into two different points, mR and mL, on the image plane (20) by the camera lens (22).

Here, all the existing spatial points are not converted through these processes but only the images existing within the narrow range decided by the internal angle (α) of the prism (14) are converted.

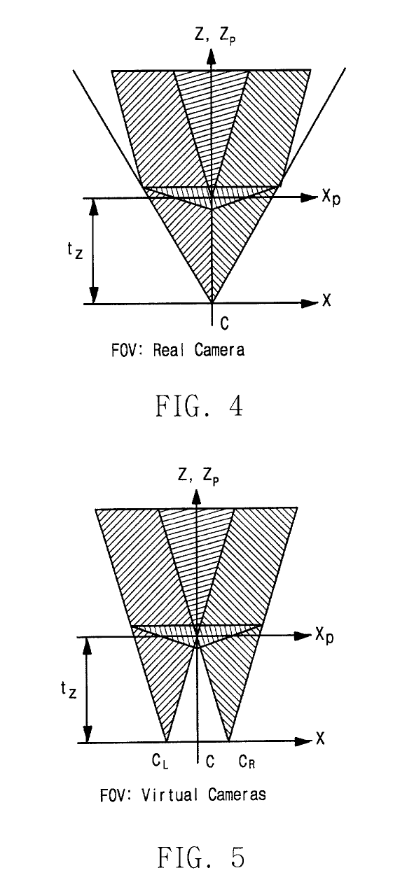

The range is illustrated in detail in FIG. 4 and FIG. 5.

FIG. 4 is a view illustrating the field of view (FOV) of a real camera using a prism in accordance with the present invention, and FIG. 5 is a view illustrating the FOV of a virtual stereo camera.

In the figures, the FOV is basically divided into three different regions: ← a region both cameras can observe, ↑ a region the left-side camera can only observe, → a region the right-side camera can only observe.

Among the regions, the region in which a single spatial point is mapped into two different points on the image plane is region ←.

Therefore, the subject for three-dimensional inspection should be placed in region ←, and then two different images can be obtained by an image processing based on the imaging principle described in FIG. 3.

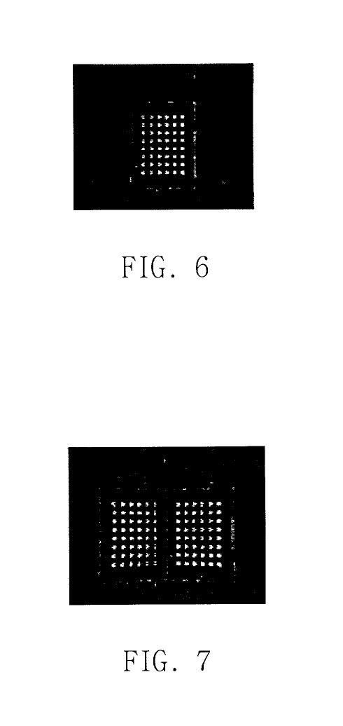

The sample images of micro-BGA package elements obtained by visual systems are illustrated in FIG. 6 and FIG. 7.

FIG. 6 shows an image obtained without using a prism and FIG. 7 shows two images obtained by using a prism in accordance with the present invention.

The image processing procedures to obtain three-dimensional information using the two images are shown in FIG. 8.

Before starting a visual inspection, calibration (S100) of a camera is performed to obtain the intrinsic parameters (focal length, scale factor, distance between the prism (14) and the image plane (20), camera constant, etc.) of the camera (12) and the prism (14) by using an object of which the exact three-dimensional information is known.

Next, reading (S102) the two images obtained by using the prism (14), extracting (S104) the characteristic points, which are corresponding to each other, from the two images, calculating (S106) the disparity between two points, the system extracts (S108) the distances to the corresponding points and the three-dimensional coordinates therefrom.

The characteristic points on the image, in the step of S104, can vary for each application field. In the case of a BGA package, the vertexes of spherical-shaped balls are used for characteristic points on the image since the image of a ball is mapped into a doughnut-shape as illustrated in FIG. 6 and FIG. 7. And in the case of an SOP element, the edges at the ends of the legs are used for characteristic points on the image since the end of the leg has a rectangular shape.

Using the three-dimensional information extracted through the step, S108, a spatial plane is presumed (S110). Thereafter, a planarity inspection (S112), which is a three-dimensional inspection, is carried out by analyzing the relative distribution of the characteristic points to the plane.

In other words, if the characteristic points are located on the presumed plane, it is considered that most characteristic points are located on the same plane, and the element is estimated as good. On the other hand, if the distance between the point and the plane is larger than the prescribed standard value, the element is estimated as bad.

For example, if the height of the ball of a BGA package or the height of the leg of an SOP element remains within a prescribed error bound so that the assembling process on a planar PCB can be carried out with no trouble, the element is estimated as good. And in the opposite cases, it is estimated as bad since some portion of the PCB contacts too tight and the other portion could have contact failure even though the PCB is assembled.

Since a certain pattern is repeated in the case of a semiconductor package, the extraction of characteristic points on the image in the step, S104, and the step, S106, is performed by following an image processing algorithm specified for its application purpose.

The three-dimensional distance according to the image disparity is calculated by the following equation:

$$\frac{1}{d} = \frac{{k}_{1}}{{Z}_{p}} + {k}_{2} , \qquad [ Equation 1 ]$$

where,

$${k}_{1} = {k}_{2} \cdot {t}_{z} , {k}_{2} = \frac{1}{2 \cdot {α}_{u} \cdot tan δ} , {α}_{u} = \frac{f}{{c}_{x}} .$$

Here, d is disparity calculated on the image, [pixel], ZP is the distance to the characteristic point, [mm], k1, k2 are intrinsic parameters of the camera (12), tZ is the distance from the image plane (20) to the prism (14), [mm], δ is the internal angle of the prism (14), [radian], f is the focal length of the camera lens (22), [mm], and cx is the length of an image sensor cell along with X-axis, [mm].

The values of k1, k2, tz, f are decided by calibration of camera (12) at step S100.

δ is decided with respect to FOV according to the size of a subject, and cx is decided by the size of the image array and the resolution of the image after the camera (12) is selected.

After the three-dimensional distances to the main characteristic points are extracted by the procedures described above, the three-dimensional coordinates of the corresponding points are calculated by trigonometry.

In other words, the three-dimensional information on the three-dimensional coordinate system, which has its origin at the center of the camera lens (22), is totally decided and the information on the n characteristic points, described below, are obtained:

(x₁, y₁, z₁), i=1,2, . . . , n, n≧4.

Here, the accuracy of the information on the three-dimensional distance can be improved by linearly interpolating the changes in brightness between neighboring pixels and using the quatized data up to the necessary number.

In other words, analyzing the resolution of the image up to the range less than a pixel and improving the resolution of the image around the characteristic points thereby, the system provides an information on the three-dimensional distance with an improved accuracy.

Next, by using a least-square method or a Hough transform, an planar equation, as described in Equation 2, is extracted (S110), and the distribution characteristics of the characteristic points to the plane is analyzed (S112). In other words, the coplanarity is inspected.

a·x+b·y+c·z=d [Equation 2]

Here, a, b, c, and d are coefficients of the planar equation extracted.

Finally, if the distance between the characteristic point and the extracted plane is larger than the standard value, the package is estimated as bad. Or, if the distance exists within a prescribed error bound, the package is estimated as good.

As mentioned thereinbefore, the present invention provides a three-dimensional visual inspection method of semiconductor packages using single camera.

For example, the three-dimensional visual inspection method in accordance with the present invention is applicable to measure the heights of the balls in a ball grid array (BGA) package which is formed by adhering an element directly to a through-hole of an electronic circuit board by heating a circular-shape lead placed at the bottom of the element, or to measure the heights of the legs in a small outline package (TSOP or TTSOP) which is formed by densely attaching numbers of very-fine legs on all sides of the element.

In addition, since the inspection method in accordance with the present invention carries out a three-dimensional visual inspection by using a single camera without using an additional special light source like a laser light source, it lowers the system price remarkably compared with the prior three-dimensional visual inspection apparatus.

Since those having ordinary knowledge and skill in the art of the present invention will recognize additional modifications and applications within the scope thereof, the present invention is not limited to the embodiments and drawings described above.

What is claimed is:

1. A three-dimensional visual inspection apparatus of semiconductor packages comprising:
a lighting means (16) that is located over the package element (18) to be inspected and lightens the element;
a prism (14) that is located over said lighting means (16) and splits the light from the package element (18) into two different optical paths;
a camera (12) that is located over said prism (14) and reads the stereo images obtained through said prism (14); and
an image processing system (10) that manipulates the stereo image signals read by said camera (12) and carries out three-dimensional visual inspection.

2. A three-dimensional visual inspection apparatus of semiconductor packages as claimed in claim 1,
wherein said prism (14) is made of a transparent material, such as a glass or a crystal, and has a trigonal shape being able to get stereo images.

3. A three-dimensional visual inspection apparatus of semiconductor packages as claimed in claim 1,
wherein said lighting means (16) is an LED lighting.

4. A three-dimensional visual inspection apparatus of semiconductor packages as claimed in claim 1,
wherein said lighting means (16) is a ring-type LED in case that said package element (18) is a BGA package.

5. A three-dimensional visual inspection method of semiconductor packages comprising the steps of:
performing a camera calibration (S100) to obtain the intrinsic parameters of a camera (12) and a prism (14) by using an object of which the exact three-dimensional information is known;
reading (S102) the stereo image that is obtained by inducing the light on a package element (18) and transmitting the light through said prism (14), which splits the light from said package element (18) into two different optical paths, and mapping a spatial point into two different points on an image plane (20) thereby;
extracting (S104) the characteristic points, which are corresponding to each other, from said two images;
calculating (S106) the disparity between two points;
extracting (S108) the d stances to the corresponding points and three-dimensional coordinates from the result of said calculating step (S106);
presuming (S110) a spatial plane using the three-dimensional information extracted through said extracting step (S108); and
performing (S112) a planarity inspection, which is a three-dimensional inspection, by analyzing the relative distribution of the characteristic points to said spatial plane.

6. A three-dimensional visual inspection method of semiconductor packages as claimed in claim 5,
wherein the characteristic points on the image in said extracting step (S104) are vertexes of spherical-shaped balls in case that said package is a BGA package.

7. A three-dimensional visual inspection method of semiconductor packages as claimed in claim 5,
wherein the characteristic points on the image in said extracting step (S104) are edges at the ends of the legs in case that said package is an SOP package.

8. A three-dimensional visual inspection method of semiconductor packages as claimed in claim 5,
wherein the three-dimensional distance in said extracting step (S108) is calculated by the following equation:
$$\frac{1}{d} = \frac{{k}_{1}}{{Z}_{p}} + {k}_{2} , \qquad [ Equation 3 ]$$
where,
$${k}_{1} = {k}_{2} \cdot {t}_{z} , {k}_{2} = \frac{1}{2 \cdot {α}_{u} \cdot tan δ} , {α}_{u} = \frac{f}{{c}_{x}} ,$$
d: disparity calculated on the image, [pixel],
ZP: distance to the characteristic point, [mm],
k1, k2: intrinsic parameters of the camera (12),
tZ: distance from the image plane (20) to the prism (14), [mm],
δ: internal angle of the prism (14), [radian],
f: focal length of the camera lens (22), [mm],
cx: length of an image sensor cell along with X-axis, [mm].

9. A three-dimensional visual inspection method of semiconductor packages as claimed in claim 5,
wherein the planar equation in the presuming step (S110) is calculated by the following equation:
a·x+b·y+c·z=d [Equation 4]
where a, b, c, and d are coefficients of the planar equation extracted.
